(19) United States
(12) Patent Application Publication
(10) Pub. No.: US 2008/0035784 A1
(43) Pub. Date: Feb. 14, 2008

(54) AIRCRAFT WAKE VORTEX PREDICTOR AND VISUALIZER

(76) Inventors: Jere S. Meserole, Bellevue, WA (US); Jay S. Pearlman, Port Angeles, WA (US); Michael S. Lewis, Round Hill, VA (US); Marissa K. Singleton, Bellevue, WA (US)

Correspondence Address: MOORE AND VAN ALLEN PLLC FOR BOEING, 430 DAVIS DRIVE, SUITE 500, MORRISVILLE, NC, 27560, US

(21) Appl. No.: 11/463,685

(22) Filed: Aug. 10, 2006

(51) Int. Cl. F41G 7/00

(52) U.S. Cl. 244/3.1

(57) ABSTRACT

A method to predict a location, intensity and movement of wake vortexes may include collecting one or more ground-based measurements related to predicting the location, intensity and movement of wake vortexes. The method may also include collecting one or more airborne-based measurements related to predicting the location, intensity and movement of wake vortexes. The method may further include integrating the ground-based and/or airborne-based measurements to predict the location, intensity and movement of wake vortexes using a wake vortex prediction model selected from a plurality of wake vortex models based on a group of inputs or parameters including the ground-based and/or airborne-based measurements.

### BACKGROUND OF THE INVENTION

The present invention relates to detecting and predicting aircraft vortexes and more particularly to an aircraft wake vortex predictor and visualizer.

Air traffic continues to grow and the capacity limitations at airports are inducing increasing flight delays. The capacity limitations come, in part, from wake turbulence created by aircraft, which limits how closely aircraft can be spaced on both takeoff and landing. These limitations apply to both single runway operations and parallel runway operations. Typically, for example, aircraft takeoffs and landing can be spaced by up to three minutes, depending on how much smaller the following aircraft is than the leading one, to allow turbulence to move off the runway and flight path, or to dissipate.

Wake turbulence is generated in the form of vortexes trailing from aircraft wingtips. The pair of vortexes created by each aircraft is a result of lift being generated by the wings and air rotating around the wing tip from the high pressure regions at the bottom of the wing to the lower pressure regions on the top of the wing. The strength of the vortexes is dependent on the aircraft speed and configuration and on the instantaneous lift being generated by the wing. While there are ways to reduce the strength of tip vortexes, they cannot be eliminated. The vortexes can severely buffet another aircraft that flies into them, and the vortexes from a transport aircraft flying at landing or take-off speeds can upend a small aircraft and cause loss of control.

Wing tip vortexes cannot be directly visualized at low altitudes, except in rare atmospheric conditions. In research experiments, wake turbulence has been measured with sophisticated and costly laser Doppler devices positioned along the flight path. The lasers may be aimed across the flight path and detect the characteristic approaching and receding air motions of the vortex. Such equipment, however, does not operate in all weather conditions and may be too costly for routine airport operations, and aircraft takeoff and landing separations are established with the assumption of worst conditions. This may apply not only to single runways but also to dual approach paths to parallel runways significantly less than a mile apart. These minimum separations are often greater than what would be adequate for complete safety if the location and movement of the vortexes were known with certainty so that they could be avoided with minor changes in flight path.

### BRIEF SUMMARY OF THE INVENTION

In accordance with an embodiment of the present invention, a method to predict a location, intensity and movement of wake vortexes may include collecting one or more ground-based measurements related to predicting the location, intensity and movement of wake vortexes. The method may also include collecting one or more airborne-based measurements related to predicting the location, intensity and movement of wake vortexes. The method may further include integrating multiple ground-based and/or airborne-based measurements to predict the location, intensity and movement of wake vortexes using a wake vortex prediction model selected from a plurality of wake vortex models based on a group of inputs or parameters that may include the ground-based and airborne-based measurements.

In accordance with another embodiment of the present invention, a method to adjust air traffic management system plans may include aggregating wake vortex information, determining vehicle deconfliction information, and determining air traffic management operational state information. The method may also include integrating the wake vortex information, vehicle deconfliction information and air traffic management operational state information to adjust air traffic management system plans to reflect any changes due to wake-dependent aircraft separation requirements.

In accordance with another embodiment of the present invention, a system to predict a location, intensity and movement of wake vortexes may include a plurality of ground-based sensors to collect data related to predicting the location, intensity and movement of wake vortexes. The system may also include an information management system in conjunction with a telecommunications network to receive airborne-based measurement data related to predicting the location, intensity and movement of wake vortexes and to receive the data from the plurality of ground-based sensors. The method may further include a wake vortex prediction model to predict at least the location and intensity of the wake vortexes from at least status information from an aircraft generating the wake vortexes.

In accordance with another embodiment of the present invention, a system to adjust air traffic management system plans may include wake vortex detection and prediction means to aggregate wake vortex detection and prediction information. The system may also include vehicle deconfliction means that generate vehicle deconfliction information. The system may further include an operations decision process to couple the wake vortex detection and prediction information, vehicle confliction information and air traffic management operational state information to adjust air traffic management system plans in real-time to reflect any changes due to wake vortex-dependent aircraft separation requirements.

In accordance with another embodiment of the present invention, an aircraft may include a plurality of sensors to determine at least a speed of the aircraft and a configuration of the aircraft and a wake vortex predictor to predict at least a location and intensity of wake vortexes being generated by the aircraft based at least on the speed and configuration of the aircraft. The aircraft may also include a transmitter to transmit wake vortex information corresponding to at least the predicted location and intensity of the wake vortexes to at least a following aircraft.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an exemplary method to predict and display a location, intensity and movement of wake vortexes in accordance with an embodiment of the present invention.

FIG. 2 is an illustration of a system to predict and display a location, intensity and movement of wake vortexes in accordance with an embodiment of the present invention.

FIG. 3A is a block diagram of an exemplary wake vortex system illustrating various data inputs or sources and output information and users relative to an air traffic management system operational change in accordance with another embodiment of the present invention.

FIG. 3B is a block diagram of the exemplary wake vortex system illustrating various data inputs and sources and outputs relative to flight operations effects in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

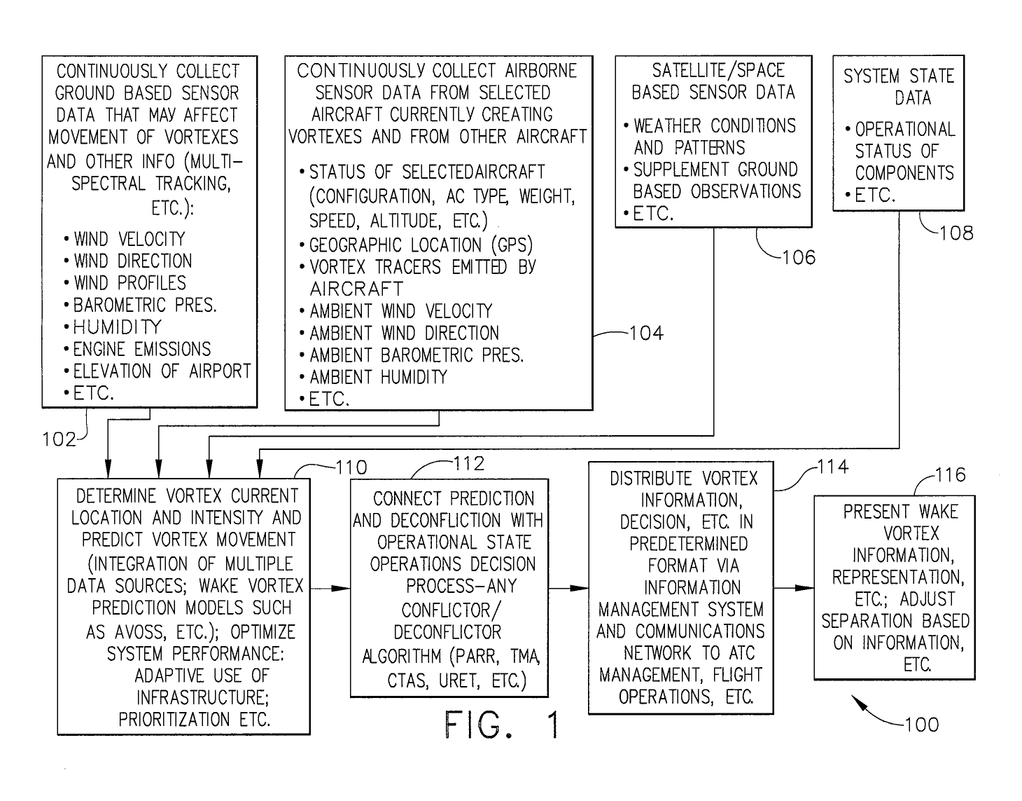

FIG. 1 is a flow chart of an exemplary method 100 to predict and display a location, intensity and movement of wake vortexes in accordance with an embodiment of the present invention. In block 102, ground-based sensor data that may affect movement of vortexes may be collected or measured. The data may be collected or measured continuously or at a predetermined frequency to conserve bandwidth and optimize system performance under some operational conditions as described in more detail herein. Examples of the data that may be collected may include, but is not necessarily limited to wind velocity, wind direction, wind profiles, barometric pressure, humidity, engine emissions, elevation of the airport and any other atmospheric or environmental data or information that may be used to detect and predict a location, intensity and movement of wake vortexes.

In block 104, airborne sensor data may be collected. The data may be collected from a selected aircraft that is generating the wake vortexes and from other aircraft. The airborne data may also be collected continuously or at a predetermined frequency to preserve bandwidth and optimize system performance depending upon conditions and operational limitations. Examples of the airborne data or information that may be collected or determined may include, but is not necessarily limited to status of a selected aircraft that may be creating or generating the wake vortexes, geographic location, ambient wind velocity, ambient wind direction, ambient barometric pressure, ambient humidity and the like. Other data may involve vortex tracers that may be emitted by a vortex tracer system mounted in the aircraft for real-time vortex detection. Such a system would emit a material or substance from the aircraft that enhances the ability of particular ground- or airborne-based sensors to detect and locate the wake vortexes generated by the aircraft. Predictor or state information may be used to aim the tracer detection system to optimize vortex detection.

Examples of parameters that define the status of a selected aircraft of interest because the aircraft is generating vortexes that may affect other aircraft may include, but may not be limited to aircraft configuration (takeoff, landing or cruise flap settings, wheels down/up, etc.), aircraft type, weight, air speed, altitude and the like. Aircraft geographic location may be determined or measured by a Global Positioning System (GPS), inertial navigation or other system or technique.

In block 106, satellite or space based sensor data may be collected. The space based sensor data may include among other information, weather conditions and patterns. The space based sensor data may supplement the ground-based observations or other observations.

In block 108, system state data or operational state information may be gathered or collected. The system state data may include operational status of the different components or elements of the system, which airport runways are in use, directions of approach and departure and the like. System state data may also include amount of air traffic congestion, measured in traffic volume and delays, wind and weather parameters that may affect movement and dissipation of wake vortexes as well as other parameters.

In block 110, vortex current location and intensity may be determined and vortex movement may be predicted. Data from the multiple sources may be integrated using technology such as System Wide Information Management (SWIM) or the like that may allow data to be read across all sources and provided by multiple different users and applications. SWIM or the like may provide portability, readability and timeliness to insure quality of the service.

Wake vortex prediction models, such as NASA Aircraft Vortex Spacing System (AVOSS) or similar prediction models may be used to predict the wake vortexes, their location, movement and intensity.

Because of the volume of data that may be received and used under some circumstances, bandwidth options may be implemented to optimize system performance. One example of such options or techniques may include adaptive use of infrastructure, such as sending more data and cycling more frequently only if needed depending upon circumstances. Another example may be an infrastructure priority/utilization option. With this option, when data are not needed, they are not sent or used, but when needed, lower priority applications or data may be overwritten or not used.

In block 112, wake vortex prediction elements or information, vehicle deconfliction elements or information and air traffic operational state information may be coupled, connected or combined to adjust air traffic management system plans in real-time to reflect any changes due to wake vortex-dependent aircraft separation requirements. The system may use any predictor/conflictor algorithms, including AVOSS, as previously discussed, and planning/deconfliction tools, such as radar, Problem Analysis, Resolution and Ranking (PARR), Enroute Descent Advisor (EDA), Traffic Management Advisor (TMA), Center-TRACON Automation System (CTAS), User Request Evaluation Tool (URET) or similar tools. Vehicle deconfliction is the process of determining the proper instructions to give to aircraft to ensure that they never come too close to one another (the limit today in the area of airports is 3 miles).

Vehicle deconfliction elements may include automation software that predicts the future positions of aircraft and then optimally determines changes to the aircraft flight paths necessary to maintain a mandatory minimum separation. Vehicle deconfliction may also include an air traffic controller, who projects ahead based on the radar display and then gives “vectors” to pilots, for them to change course.

Air traffic operational state information may include runways that may be in use at an airport, the direction of approach, and the particular approach path, which may be selected because of weather conditions at the time, especially wind direction. Air traffic operational state information may also include the amount of congestion, measured in traffic volume and delays. In accordance with an embodiment of the present invention, another relevant parameter may be the weather, wind speed and direction and how this may affect movement and dissipation of the wake vortexes.

In block 114, wake vortex information, decisions or other data may be distributed in a predetermined format via an information management system and communications or telecommunications network to predetermined entities, such as air traffic control (ATC), flight operations, individual aircraft, airlines, military or the other entities having a need or use for the information or data. The information may be sent in different formats to the different entities to facilitate their respective uses. The information may be distributed over the same information management system and communications network used to receive data from the various sources as described above.

In block 116, wake vortex information, a wake vortex representation, visualization or the like may be presented to the respective users. As previously discussed, the wake vortex information or visualization may be used to adjust separation between aircraft and increase the frequency of takeoffs and landings. The visualization may be an overlay on a radar screen or other display.

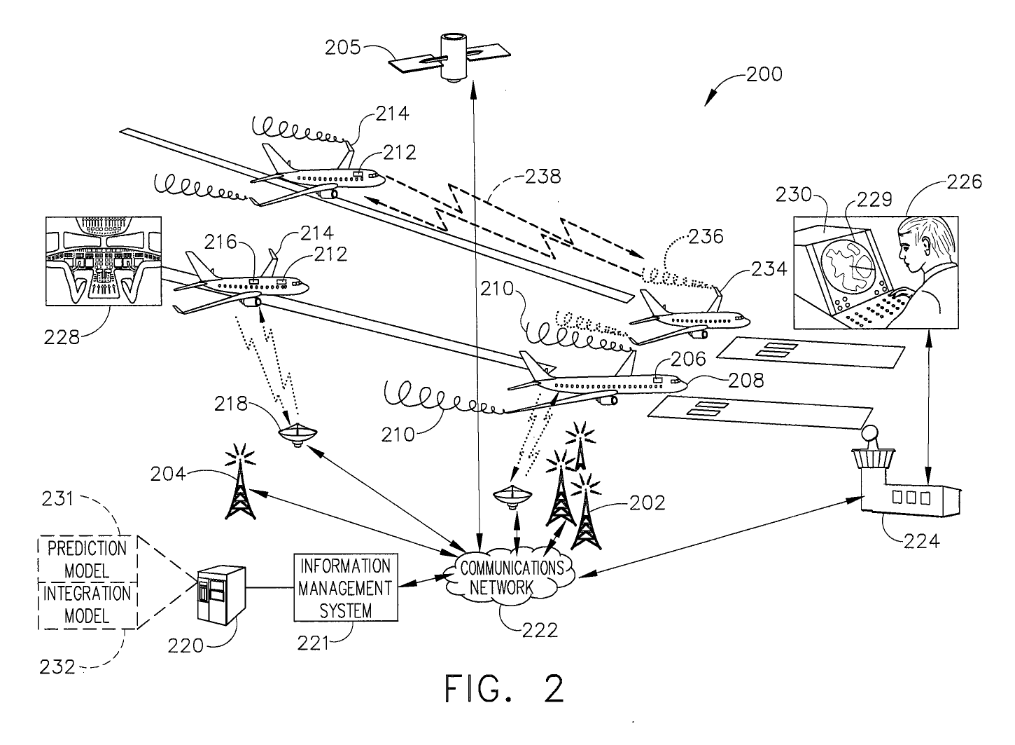

FIG. 2 is an illustration of a system 200 to predict and display a location, intensity and movement of wake vortexes in accordance with an embodiment of the present invention. The method 100 may be embodied in the system 200. The system 200 may include a plurality of ground-based sensors. For example, there may be multi-spectral tracking sensors 202 to detect aircraft engine emissions, air pressure changes and the like to locate wake vortexes. The system may also include area weather sensors 204 to detect weather conditions, such as wind velocity and direction, air temperature, barometric pressure, humidity and any other atmospheric or environmental conditions that may be applicable to detecting and predicting wake vortex location, intensity and movement.

The system 200 may also include space-based sensors 205. The space-based sensors 205 may include multi-spectral sensors to supplement ground-based sensors 202 and 204. The space-based sensors may detect weather conditions or weather patterns or gather other information that may be useful in detecting and predicting the location, intensity and movement of wake vortexes.

The system may also include airborne sensors 206 to provide data from a selected aircraft 208 generating wake vortexes 210. The airborne sensors may also include sensors 212 on other aircraft 214 to provide information or data that may be used in detecting and predicting wake vortex location, intensity and movement. As previously discussed, data from the selected aircraft 208 generating the wake vortexes 210 may include data related to a status of the aircraft, such as configuration, aircraft type, weight, speed, altitude, geographic location and any other information that may be used in determining or predicting the wake vortex location, intensity and movement from the selected aircraft 208. The selected aircraft 208 may also have sensors 206 to sense atmospheric conditions.

The sensors 212 on another aircraft 214 may measure or collect similar data. The other aircraft 214 may include a prediction model 216 to compute or predict wake vortexes from data received from a ground station 218 or may receive the vortex predictions calculated or determined from a ground-based processing system 220. The ground-based processing system 220 may receive the ground-based data and airborne-based data through an information management system 221 operating in conjunction with a telecommunications network 222 or other communications network. Wake vortex predictions, analysis and other results may also be distributed to aircraft, air traffic services (ATS) facilities 224, and other users using the same information system 221 and telecommunications network 222. The network 222 may include elements for air-to-ground communication, air-to-air communication, communication with satellites 205, wireless and wire line communications.

A representation 226 of the location, intensity, and movement of the wake vortexes relative to any geographical landmarks and other aircraft may be presented to air traffic controllers at the ATS facilities 224, may be presented to pilots on a flight deck display 228 of an aircraft, and to others. The representation may be an electronic overlay 229 on an air traffic display 230 or radar display.

The processing system 220 may be considered as an additional element operating in conjunction with the information system and telecommunications network 222. The processing system 220 may include a prediction model 231 and an integration model 232. The prediction model 231 or wake vortex prediction model may predict at least the location and intensity of the wake vortexes 210 from at least the status information from the selected aircraft 208 generating the wake vortexes 210. The integration model 232 may determine the location, intensity and movement of the wake vortexes based on a combination of the data collected by the sensors and data from the wake vortex prediction model 231.

The system 200 may also include a vortex tracer system 234 or the like that emits a material or substance 236 from an aircraft that enhances the ability of particular ground- or airborne-based sensors to detect and locate the vortexes generated by the aircraft. Aircraft may also share information via air-to-air communications 238 for real-time vortex prediction and detection.

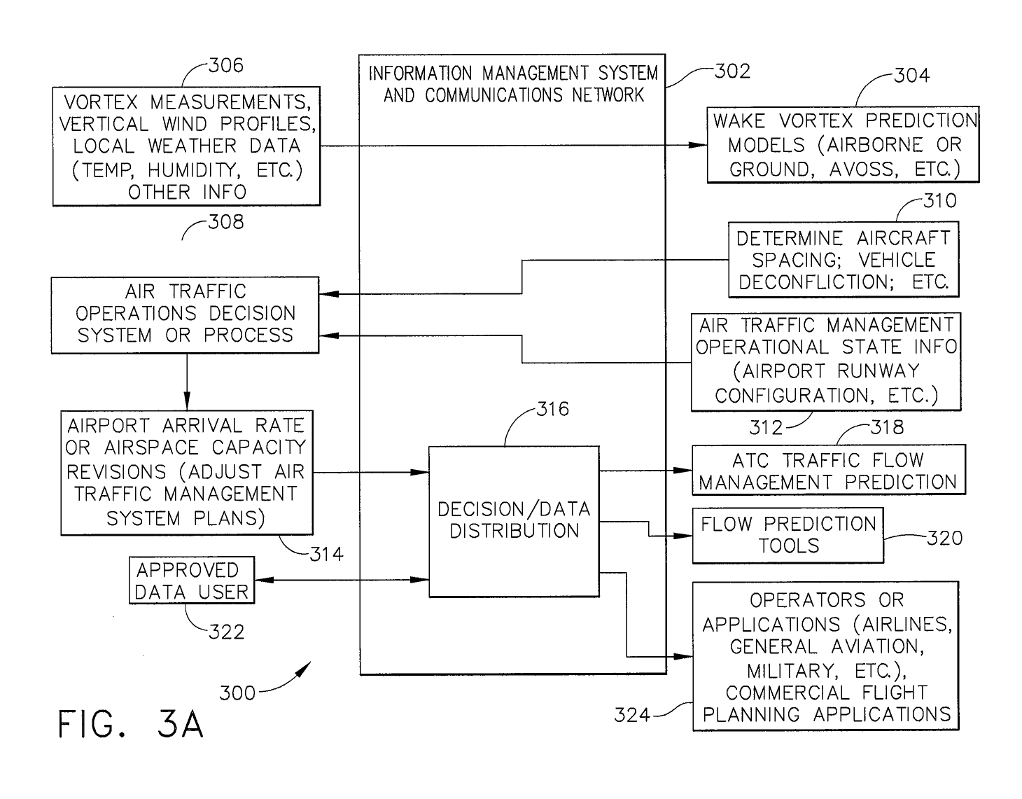

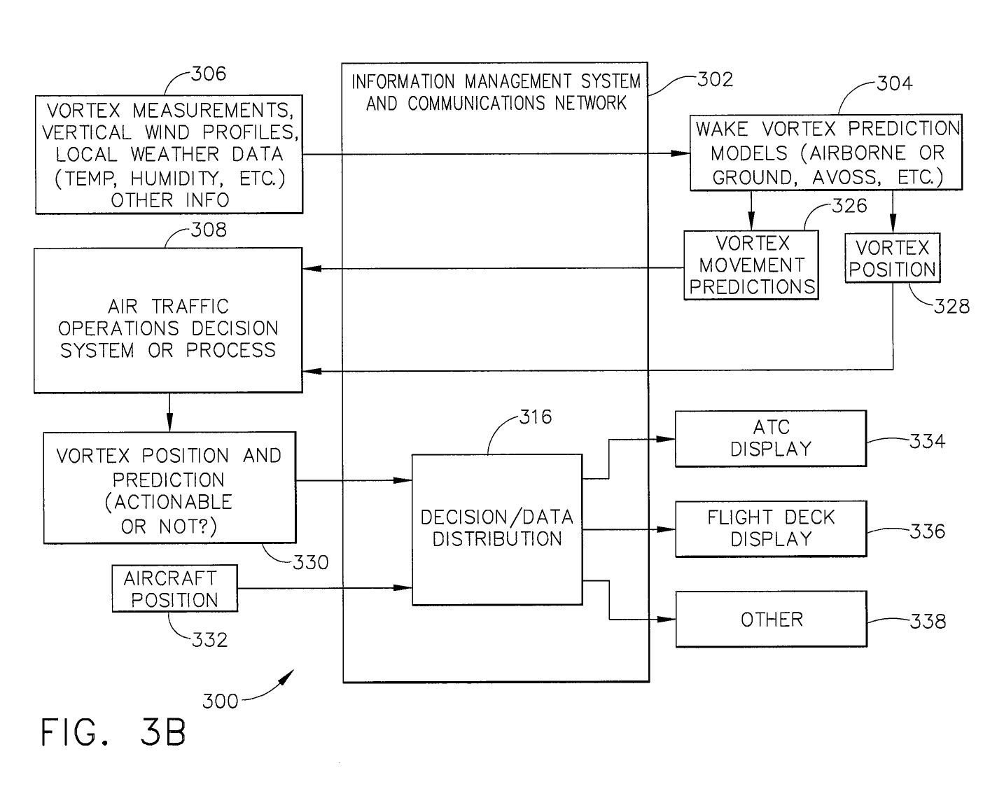

FIG. 3A is a block diagram of an exemplary wake vortex system 300 illustrating various data inputs or sources and output information relative to an air traffic management system operational change in accordance with another embodiment of the present invention. The system 300 may be an information management system or the like. Elements of the system 300 may be embodied in the system 200 of FIG. 2. The system 300 may include an information management system and telecommunications network 302. The information management system and communications network 302 may be used for the information management system 221 and network 222 and processing system 220 of system 200. The network 302 may provide data to wake vortex prediction models 304. The models 304 may reside at a ground station similar to prediction model 231 in FIG. 2 or may be airborne similar to model 216 of FIG. 2. The wake prediction models 304 may be NASA AVOSS type models or the like similar to that previously discussed. The vortex model may receive ground-based and airborne-based sensor data 306 that may include aircraft state data, vortex location indicated by sensor measurements, vertical wind profiles, local weather data and other information that may be useful in predicting wake vortexes. A particular wake vortex prediction model may be selected from a plurality of wake vortex models based on the inputs or parameters.

The system 300 may also include an air traffic operations decision system or process 308. The air traffic operations decision system or process 308 may also receive data through the network 302. Wake vortex prediction information from block 304, vehicle deconfliction information 310, and air traffic management operational state information 312 may be coupled or combined by the air traffic operations decision system 308 to adjust air traffic management system plans in real-time to reflect any changes due to wake vortex-dependent aircraft separation requirements. The adjustment to air traffic management system plans may result in airport arrival rate or airspace capacity revisions 314.

In block 316, the decisions relative to adjustment to the air traffic management system plans and other data may be distributed via the network 302. The decision/data may be sent to ATC traffic flow management prediction 318 and to air traffic flow prediction tools 320 for additional analysis and review. The data may also be sent to approved data users 322 and operators or applications 324, such as airlines, general aviation, military or others for flight plan applications or other uses. The system 300 or network 302 may typically only be accessed through a secure interface and on an “as needed” basis. The system 300 allows data to be readable over all sources and to be available to many different applications. The system 300 may also allow portability, readability and timeliness for quality of service.

FIG. 3B is a block diagram of the exemplary wake vortex system 300 illustrating various data inputs and sources and outputs relative to flight operations effects in accordance with another embodiment of the present invention. Similar to that described in FIG. 3A, the wake vortex prediction models 304 may receive as inputs from ground and airborne sensors or from other sources, such as aircraft state data, vortex location indicated by sensor measurements, vertical wind profiles, local weather data or other information that may be useful in predicting location and movement of wake vortexes, as represented by block 306. A particular wake vortex model may be selected from a plurality of wake vortex models based on the inputs or parameters 306. The selected wake vortex model 304 may provide vortex movement predictions 326 and vortex position or location 328.

The vortex movement predictions 326 and vortex position 328 may be applied to the air traffic operations decision system or process 308 to determine whether the vortex position and movement prediction warrants taking action in block 330, such as making adjustments to aircraft spacing as previously described or other actions. Any decision and the vortex location and movement prediction data or information may be distributed via the network 302 in block 316. Aircraft position information may be integrated with the vortex information in block 316. The vortex information may then be distributed for presentation or display to Air Traffic Control (ATC) 334, aircraft that may be affected by the wake vortexes and presented on a flight deck display 336 and any other recipients, such as the Federal Aviation Administration (FAA) or other entities for review and analysis or for other purposes.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method to predict a location, intensity and movement of wake vortexes, comprising:
collecting one or more ground-based measurements related to predicting the location, intensity and movement of wake vortexes;
collecting one or more of airborne-based measurements related to predicting the location, intensity and movement of wake vortexes; and
integrating the ground-based and the airborne-based measurements to predict the location, intensity and movement of wake vortexes using a wake vortex prediction model selected from a plurality of wake vortex prediction models based on a group of inputs or parameters including the ground-based and the airborne-based measurements.

2. The method of claim 1, further comprising distributing information related to prediction of the location, intensity and movement of wake vortexes to at least air traffic control and any aircraft possibly affected by the wake vortexes.

3. The method of claim 2, wherein collecting the one or more ground-based measurements, collecting the one or more airborne-based measurements and distributing information related to prediction of the location, intensity and movement of wake vortexes is accomplished through an information management system in conjunction with a communications network.

4. The method of claim 1, further comprising adjusting an air traffic management system in real-time to reflect any changes due to wake vortex-dependent aircraft separation requirements.

5. The method of claim 1, further comprising combining wake vortex prediction information, vehicle deconfliction information and air traffic management operational state information to adjust air traffic management system plans in real-time to reflect any changes due to wake vortex-dependent aircraft separation requirements.

6. The method of claim 1, wherein predicting the location, intensity and movement of wake vortexes from an aircraft generating the wake vortexes comprises:
determining a speed of the aircraft generating the wake vortexes;
determining a type of the aircraft generating the wake vortexes;
determining a configuration of the aircraft generating the wake vortexes;
determining or predicting local winds in the vicinity of the aircraft generating the wake vortexes; and
tracking a ground track of the aircraft generating the wake vortexes.

7. The method of claim 1, wherein predicting the location, intensity and movement of wake vortexes is performed on board an aircraft generating the wake vortexes, and wherein the method further comprises transmitting information related to predicting the location, intensity and movement of the wake vortexes to a following aircraft.

8. The method of claim 1, wherein predicting the location, intensity and movement of the wake vortexes from an aircraft generating the wake vortexes is performed at a ground station using information from the wake vortex generating aircraft, and wherein the method further comprises transmitting the information related to the location, intensity and movement of the wake vortexes to a following aircraft.

9. The method of claim 1, further comprising at least one of:
collecting wind information from a plurality of aircraft landing in a rapid sequence; and
collecting wind information from a plurality of ground sensors.

10. The method of claim 1, further comprising presenting a representation of the location, intensity and movement of the wake vortexes relative to any geographic landmarks and other aircraft.

11. The method of claim 10, wherein the representation is electronically overlaid on an air traffic display or radar display.

12. The method of claim 1, further comprising supplementing the measurements with space-based sensor information.

13. The method of claim 1, further comprising detecting wake vortexes by use of tracer material or substance emitted by an aircraft generating the wake vortexes.

14. The method of claim 1, further comprising determining the location, intensity and movement of wake vortexes based on a combination of sensor data and vortex predictor data.

15. A method to predict a location, intensity and movement of wake vortexes, comprising:
determining a speed of an aircraft generating the wake vortexes;
determining a type of the aircraft generating the wake vortexes;
determining a configuration of the aircraft generating the wake vortexes;
determining or predicting local winds in a vicinity of the aircraft generating the wake vortexes;
tracking a ground track of the aircraft generating the wake vortexes; and
predicting the location, intensity and movement of the wake vortexes from at least the speed, type, configuration, ground track of the aircraft generating the wake vortexes, and local winds or local winds prediction in the vicinity of the aircraft generating the wake vortexes.

16. The method of claim 15, further comprising receiving data, performing analysis and distributing results of the analysis related to the location, intensity and movement of wake vortexes using a network.

17. The method of claim 15, further comprising determining the location, intensity and movement of the wake vortexes based on data from a plurality of sensors and data from a predictor model.

18. The method of claim 17, further comprising receiving sensor data from at least one of a ground-based sensor, a sensor on the aircraft generating the wake vortexes, a sensor on at least one other aircraft, and a space-based sensor.

19. The method of claim 15, further comprising combining wake vortex information, vehicle deconfliction information and air traffic management operational state information to adjust air traffic management system plans to reflect any changes due to wake-vortex-dependent aircraft separation requirements.

20. A method to adjust air traffic management system plans, comprising:
aggregating wake vortex information;
determining vehicle deconfliction information;
determining air traffic management operational state information; and
integrating wake vortex information, vehicle deconfliction information and air traffic management operational state information to adjust air traffic management system plans to reflect any changes due to wake-dependent aircraft separation requirements.

21. The method of claim 20, wherein generating wake vortex information comprises:
determining a speed of an aircraft generating the wake vortexes;
determining a type of the aircraft generating the wake vortexes;
determining a configuration of the aircraft generating the wake vortexes;
determining or predicting local winds in a vicinity of the aircraft generating the wake vortexes;
tracking a ground track of the aircraft generating the wake vortexes; and
predicting a location, intensity and movement of the wake vortexes from at least the speed, type, configuration, ground track of the aircraft generating the wake vortexes, and local winds or local winds prediction in the vicinity of the aircraft generating the wake vortexes.

22. The method of claim 20, further comprising receiving the information, performing analysis on the information and distributing results of the analysis using a network.

23. The method of claim 20, wherein generating wake vortex information comprises receiving data from a plurality of sensors and data from a predictor model.

24. The method of claim 20, further comprising receiving wake vortex information from at least one of a ground-based sensor, a sensor on the aircraft generating the wake vortexes, a sensor on at least one other aircraft, and a space-based sensor.

25. The method of claim 20, further comprising optimizing performance of a wake vortex detection and prediction system by at least one of:
adaptive use of infrastructure by sending a predetermined amount of data and cycling to collect and send data at a particular frequency based on operational parameters;
sending certain data only when needed;
using certain data only when needed; and
overwriting lower priority applications.

26. A system to predict a location, intensity and movement of wake vortexes, comprising:
a plurality of ground-based sensors to collect data related to predicting the location, intensity and movement of wake vortexes;
an information management system and communications network to receive airborne-based measurement data related to predicting the location, intensity and movement of wake vortexes and to receive the data from the plurality of ground-based sensors; and
a wake vortex prediction model to predict at least the location and intensity of the wake vortexes from at least status information from an aircraft generating the wake vortexes.

27. The system of claim 26, further comprising an integration model to determine the location, intensity and movement of the wake vortexes based on a combination of the data collected by the sensors and data from the wake vortex prediction model.

28. The system of claim 26, wherein the information management system and communications network is usable to distribute information related to predicting the location, intensity and movement of wake vortexes to at least air traffic control and any aircraft possibly affected by the wake vortexes.

29. The system of claim 26, further comprising an operations decision process to couple wake vortex detection and prediction information, vehicle deconfliction information and air traffic management operational state information to adjust air traffic management system plans in real-time to reflect any changes due to wake vortex-dependent aircraft separation requirements.

30. The system of claim 26, wherein the airborne-based data received via the information management system and communications network comprises:
a speed of a selected aircraft generating the wake vortexes;
a type of the selected aircraft;
a configuration of the selected aircraft; and
local winds in the vicinity of the selected aircraft.

31. The system of claim 26, wherein the airborne data received by the information management system and communications network comprises data from a selected aircraft generating wake vortexes and data from other aircraft.

32. The system of claim 26, wherein the information management system and communications network collects wind information from at least one of a plurality of aircraft landing in a sequence and from a plurality of ground sensors.

33. A system to adjust air traffic management system plans, comprising:
wake vortex detection and prediction means to generate wake vortex detection and prediction information;
vehicle deconfliction means to generate vehicle deconfliction information; and
an operations decision process to couple the wake vortex detection and prediction information, vehicle confliction information and air traffic management operational state information to adjust air traffic management system plans in real-time to reflect any changes due to wake vortex-dependent aircraft separation requirements.

34. The system of claim 33, further comprising a wake vortex prediction model to predict at least the location and intensity of wake vortexes from at least status information from a selected aircraft generating the wake vortexes.

35. The system of claim 34, further comprising an integration model to determine the location, intensity and movement of the wake vortexes based on a combination of the data collected by a plurality of sensors and data from the wake vortex prediction model.

36. An aircraft, comprising:
a plurality of sensors to determine at least a speed of the aircraft and a configuration of the aircraft;
a wake vortex predictor to predict at least a location and intensity of wake vortexes being generated by the aircraft based at least on the speed and configuration of the aircraft; and
a transmitter to transmit wake vortex information corresponding to at least the predicted location and intensity of the wake vortexes to at least a following aircraft.

37. The aircraft of claim 36, further comprising a display to present wake vortex information of another aircraft.

38. The aircraft of claim 36, further comprising a display to present a representation of the location, intensity and a predicted movement of wake vortexes of another aircraft relative to the aircraft.

39. The aircraft of claim 36, further comprising vortex tracers for emission from the aircraft for vortex detection.

40. The aircraft of claim 36, further comprising:
a tracer system for vortex detection; and
means to aim tracer detection sensors.
